(19) United States
(12) Patent Application Publication
(10) Pub. No.: US 2020/0276463 A1
(43) Pub. Date: Sep. 3, 2020

(54) SUPPORT POST ASSEMBLY

(71) Applicant: CHECKMATE LIFTING & SAFETY LTD, Kent (GB)

(72) Inventors: William Newing, Sheerness (GB); Chris Stockbridge, Sittingbourne (GB); Oliver Auston, Faversham (GB)

(73) Assignee: CHECKMATE LIFTING & SAFETY LTD, Kent (GB)

(21) Appl. No.: 16/755,658

(22) PCT Filed: Oct. 15, 2018
(86) PCT No.: PCT/GB2018/052965

§ 371 Date: Apr. 13, 2020

(30) Foreign Application Priority Data
Oct. 16, 2017 (GB) 1716993.9

(51) Int. Cl. A62B 35/00; A62B 35/04; E04G 21/32

(52) U.S. Cl. CPC A62B 35/0068; E04G 21/329; A62B 35/04

(57) ABSTRACT

This invention relates to a safety line system for use by a person working at a height above the ground. In particular the invention relates to a support post for a safety line system. A support post assembly for supporting a fall safety line comprises a base; a support post to which a fall safety line is connectable, the support post having a longitudinal axis; cooperating curved bearing surfaces disposed between the base and the support post; and a detent assembly for preventing relative movement of the bearing surfaces below a threshold force, application of a force to the support post by the fall safety line above the threshold force causing the support post to pivot with respect to the base such that the bearing surfaces slide with respect to each other and friction between the bearing surfaces dissipates energy.

### BACKGROUND

This invention relates to a safety line system for use by a person working at a height above the ground. In particular the invention relates to a support post for a safety line system.

When a person is working at height they will typically be connected to a secure mounting by means of a lifeline attached between the mounting and a harness worn by the person. In some circumstances, the secure mounting is in the form of a secure safety line or rail provided across or around a raised area in which the person is working.

The person is typically attached to this safety line or rail by means of a lanyard attached at one end to the harness and at the other end to a traveller engaged with and able to slide along the safety line or rail. As such, as the person moves around, the traveller is pulled along the safety rail by the lanyard so as to follow the person around the raised area.

The safety line or rail is typically mounted on and supported by a number of support posts at intervals along its length. Support posts may be provided, in particular, at corners of the raised area, so as to provide a means for guiding the safety line or rail smoothly around the corner. The support posts are configured to maintain the safety line or rail in the desired position while allowing the person to move around relative to the safety line or rail without any interference from the support posts.

One problem with these systems is that, when a person falls, although some of the energy of the fall may, for example, be absorbed by the lanyard, the relative rigidity of the support posts means that little energy is absorbed by these supports.

It is known to provide support posts that have some resilience; however, the amount of energy absorbed or dissipated by the support post is still relatively low compared to the total energy of the fall.

It is, therefore, an object of the present invention to provide an improved safety line system and in particular an improved support post for a safety line system which is able to absorb some of the energy from the fall of a person secured to the safety line.

### SUMMARY OF THE INVENTION

The present invention provides a support post assembly for supporting a fall safety line comprising:
a base;
a support post to which a fall safety line is connectable, the support post having a longitudinal axis;
cooperating curved bearing surfaces disposed between the base and the support post; and
a detent assembly for preventing relative movement of the bearing surfaces below a threshold force, application of a force to the support post by the fall safety line above the threshold force causing the support post to pivot with respect to the base such that the bearing surfaces slide with respect to each other and friction between the bearing surfaces dissipates energy.

The fall safety line is preferably connectable to the support post at an end of the support post furthest from the base. The support post may be elongate and extend between first and second ends; the base being connected to the first end of the support post and the fall safety line being connected to the second end of the support post.

An axis of rotation about which the support post pivots with respect to the base due to said relative sliding of the bearing surfaces is preferably transverse to the longitudinal axis of the support post. In preferred embodiments the axis of rotation about which the support post pivots with respect to the base due to said relative sliding of the bearing surfaces is substantially perpendicular to the longitudinal axis of the support post.

In some embodiments the assembly comprises a single axis of rotation about which the support post pivots with respect to the base due to said relative sliding of the bearing surfaces. The support post is preferably able to pivot in two opposite directions about said axis of rotation depending on the direction of the applied force.

The support post may also be rotatable relative to the base about its longitudinal axis. In some embodiments the base comprises a base plate securable to a structure and the support post assembly comprises a coupling member disposed between one of the bearing surfaces and the base plate permitting rotation of the bearing surfaces and support post relative to the base plate about the longitudinal axis of the support post. This permits rotational alignment of the support post relative to the direction of the applied force such that the axis of rotation about which the support post pivots with respect to the base due to said relative sliding of the bearing surfaces extends substantially perpendicularly to the direction of the applied force.

In some embodiments the assembly comprises a plurality of axes of rotation about which the support post can pivot with respect to the base due to said relative sliding of the bearing surfaces. The support post assembly may comprise a ball and socket joint between the support post and the base.

The support post preferably pivots with respect to the base through an angle of between 45° and 135°. More preferably the support post pivots with respect to the base through an angle of about 90°.

In preferred embodiments the support post comprises a first one of the curved bearing surfaces and the base comprises a second one of the curved bearing surfaces, the first bearing surface having a convex curvature and the second bearing surface having a concave curvature. The first bearing surface may be provided by a first bearing plate and the second bearing surface may be provided by a second bearing plate. In some embodiments each of the first and second bearing plates includes an elongate slot extending along a direction of curvature of the bearing plate, and a pin extends through said slots to connect the bearing plates.

A support post assembly according to the present invention preferably further comprises a retaining assembly configured to retain the bearing surfaces in contact with each other. The retaining assembly is preferably adjustable to vary the frictional force between the bearing surfaces during relative sliding of the bearing surfaces. The retaining assembly may be configured to apply a clamping force to the bearing surfaces.

In a particularly preferred embodiment the retaining assembly and the detent assembly are provided by a single clamping assembly configured to apply a clamping force to the bearing surfaces. In some embodiments the clamping assembly comprises a first clamping member arranged to apply a force to the first bearing plate and a second clamping member arranged to apply a force to the second bearing plate. In embodiments in which each of the first and second bearing plates includes an elongate slot extending along a direction of curvature of the bearing plate and a pin extends through the slots, the clamping assembly may comprise a first clamping member arranged to apply a force to the first bearing plate and a second clamping member arranged to apply a force to the second bearing plate, the first and second clamping members being connected by the pin.

The clamping assembly may comprise a spacer disposed between the first and second clamping members, the spacer limiting the minimum distance between the first and second clamping members. In embodiments comprising a pin extending through slots in the bearing plates, the spacer may comprise a tubular member surrounding a shaft of the pin.

The detent assembly may comprise a shear pin configured to break at the threshold force.

The support post assembly preferably further comprises a mounting member connected to the support post, a fall safety line being engageable with the mounting member. The mounting member is preferably pivotally connected to the support post.

In preferred embodiments the support post comprises a shock absorber and the mounting member is connected to the support post by the shock absorber. The shock absorber preferably comprises a resilient element and a force applied to the mounting member by the fall safety line preferably causes a part of the resilient element to be deformed. In some embodiments the shock absorber may comprise a first resilient element on a first side of said pivotal connection and a second resilient element on a second side of said pivotal connection. Movement of the mounting member due to a force applied by the fall safety line preferably causes both of the first and second resilient elements to deform. The or each resilient element may be an elastomeric block. The mounting member may extend through a bore in the or each resilient block.

Preferably the shock absorber and the detent assembly are configured such that application of a force to the mounting member by the fall safety line above the threshold force fully deforms the shock absorber and subsequently transmits a force to one of the bearing surfaces to cause the bearing surfaces to slide with respect to each other.

The support post preferably pivots with respect to the base between an initial configuration and an activated configuration. In the activated position a part of the support post is preferably seated on a part of the base.

The present invention also provides a fall safety line system comprising:
a support post assembly including a base, a support post, cooperating curved bearing surfaces disposed between the base and the support post, and a detent assembly for preventing relative movement of the bearing surfaces below a threshold force; and
a fall safety line connected to the support post, the application of a force to the support post by the fall safety line above the threshold force causing the support post to pivot with respect to the base such that the bearing surfaces slide with respect to each other and friction between the bearing surfaces dissipates energy.

The fall safety line is preferably connected to an end of the support post furthest from the bearing surfaces. The fall safety line preferably extends from the support post in a direction transverse to a longitudinal axis of the support post. In some embodiments the fall safety line will extend from the support post towards a support post of a neighbouring support post assembly.

In preferred embodiments the support post comprises a shock absorber, and the fall safety line is attached to a mounting member which is connected to the shock absorber.

A support post assembly of the present invention will preferably be attached to a structure on or around which a person is working. The support post assembly may be attached to a structure at a height above the ground.

### BRIEF DESCRIPTION OF THE DRAWINGS

The invention will now be further described by way of example only and with reference to the accompanying drawings in which:

FIG. 1 is a perspective view of a support post assembly according to a preferred embodiment of the present invention;

FIG. 2 is a side view of the support post assembly of FIG. 1;

FIG. 3 is a longitudinal, vertical cross sectional view through the support post assembly of FIG. 1;

FIG. 4 is a side view of the support post assembly of FIG. 1 showing the support post in a first partially pivoted configuration;

FIG. 5 is a side view of the support post assembly of FIG. 1 showing the support post in a second partially pivoted configuration;

FIG. 6 is a side view of the support post assembly of FIG. 1 showing the support post in a fully pivoted activated configuration;

FIG. 7 is a perspective view of a lower bearing component of the support post assembly of FIG. 1;

FIG. 8 is a plan view from above of the lower bearing component of FIG. 7;

FIG. 9 is a plan view from below of an upper bearing component of the support post assembly of FIG. 1 configured to engage with the lower bearing component;

FIG. 10 is a longitudinal cross sectional view of the upper bearing component, along the line X-X of FIG. 9;

FIG. 11 is a longitudinal cross sectional view of the lower bearing component, along the line XI-XI of FIG. 8;

FIG. 12 is a transverse cross sectional view of the upper bearing component, along the line XII-XII of FIG. 9;

FIG. 13 is a longitudinal cross sectional view of the lower bearing component, along the line XIII-XIII of FIG. 8;

FIG. 14 is a cross sectional view of a clamp assembly for applying a clamping force to the upper and lower bearing components;

FIG. 15 is a perspective view of an upper clamp member of the clamp assembly;

FIG. 16 is an end view of the upper clamp member of FIG. 15;

FIG. 17 is a side view of the upper clamp member of FIG. 15;

FIG. 18 is a cross sectional view of the upper clamp member along the line XVIII-XVIII of FIG. 16;

FIG. 19 is a perspective view of a lower clamp member of the clamp assembly;

FIG. 20 is an end view of the lower clamp member of FIG. 19;

FIG. 21 is a side view of the lower clamp member of FIG. 19;

FIG. 22 is a cross sectional view of the lower clamp member along the line XXII-XXII of FIG. 20; and

FIG. 23 is a perspective view of a spacer of the clamp assembly.

### DETAILED DESCRIPTION

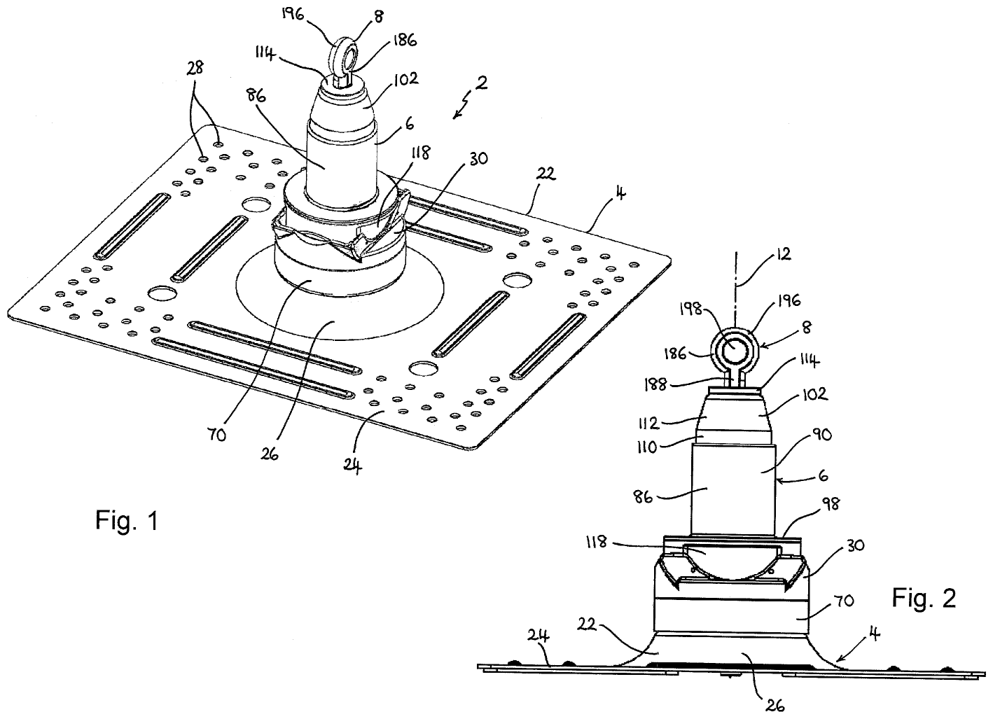

FIGS. 1 and 2 show a support post assembly 2 according to a preferred embodiment of the present invention. The support post assembly 2 is configured to support a fall safety line or fall safety rail to which a person will typically be attached by a personal safety line or lanyard and a harness. The support post assembly 2 is preferably mounted on a structure on which the person is working. The support post assembly 2 may form part of a safety line system for a person working at height and, accordingly, the support post assembly 2 may be mounted at a distance above the ground.

The support post assembly 2 comprises a base 4, a support post 6 and a safety line mount 8. The base 4 is securable to a structure, and the base 4 is preferably located within or proximate the area in which a person is working. The base 4 may be located at a corner of an area in which a person is working at height. The support post 6 is attached to the base 6 at a first end of the post 10 and extends from the base 4 along a longitudinal axis 12 of the support post 6. The safety line mount 8 is attached to the support post 6 at a second end of the post 14.

The support post 6 is attached to the base 4 such that the support post 6 is moveable with respect to the base 4. In particular, the connection between the base 4 and the support post 6 permits turning or pivoting movement of the support post 6 with respect to the base 4 about an axis 16 that is substantially perpendicular to the longitudinal axis 12 of the support post 6. The connection between the support post 6 and the base 4 is configured such that the support post 6 remains connected to the base 4 during this pivoting movement.

Advantageously the relative pivoting movement is facilitated by a cooperating pair of bearing surfaces 18, 20; a first bearing surface 18 being provided on a part of the base 4 and a second bearing surface 20 being provided on a part of the support post 6. The bearing surfaces 18, 20 are curved and may form part of a hinge joint or a ball and socket joint between the support post 6 and the base 4.

In the event of a fall of a person attached to the support post assembly 2 by a safety line or equivalent, a dynamic force is applied to the safety line mount 8. This in turn applies a lateral force to the second end of the support post 14. The connection between the support post 6 and the base 4 is configured such that, when the lateral force applied to the support post 6 exceeds a threshold value, the support post 6 turns or pivots relative to the base 4. Friction between the cooperating bearing surfaces 18, 20 dissipates some of the energy of the fall and minimises the peak loads experienced by the falling person.

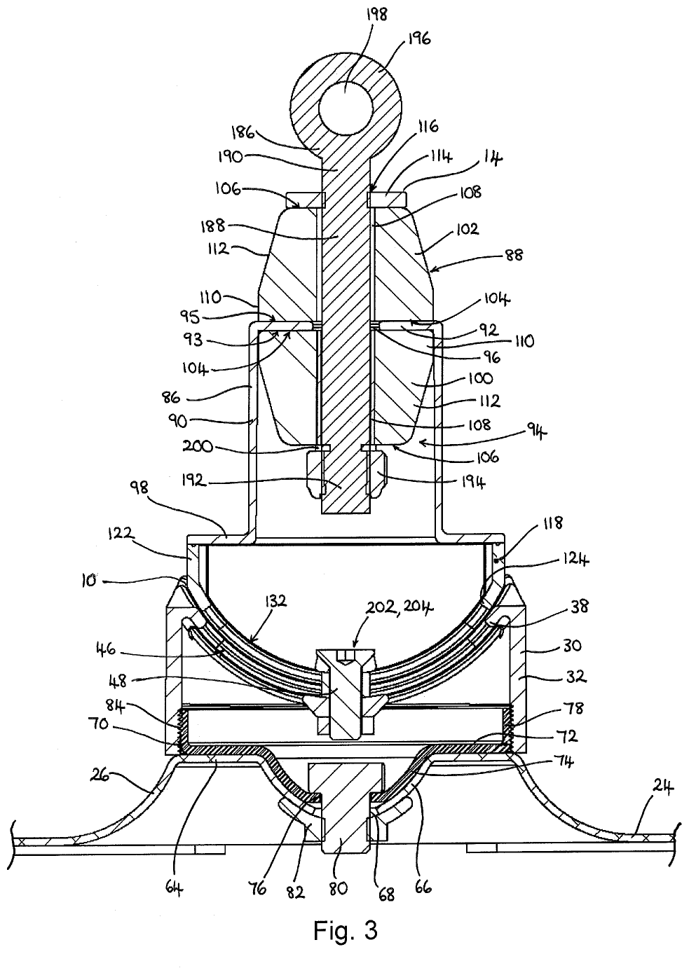

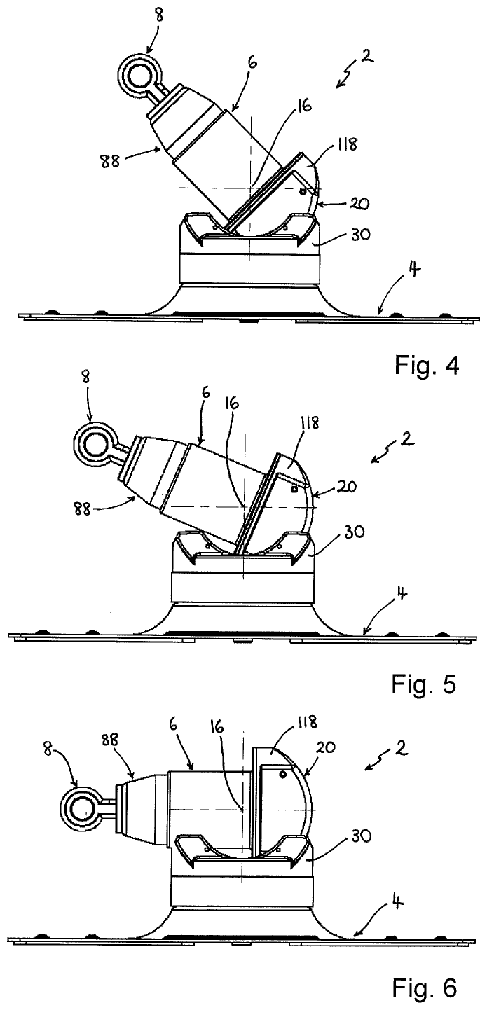

FIGS. 3 to 5 illustrate pivoting or turning of the support post 6 relative to the base 4 in a preferred embodiment of the invention. Preferably the support post 6 pivots about a centre of rotation that lies on the longitudinal axis 12 of the post 6. The support post 6 is preferably configured to turn through an angle of not more than about 135°, preferably not more than about 120°, and more preferably not more than about 90°. In use the support post 6 may turn through an angle of between 45° and 135°. The support post 6 preferably turns through a maximum angle of 90°.

In a typical situation, the base 4 of the support post assembly 2 will be secured to a horizontal surface or platform and the support post 6 will extend vertical upwards from the base 4, as shown in FIG. 1. If sufficient dynamic lateral force is applied to the support post 6 by the safety line mount 8, the support post 6 will pivot with respect to the base 4 until the longitudinal axis 12 of the post 6 is substantially horizontal, as shown in FIG. 5. Further turning of the support post 6 with respect to the base 4 may be prevented by contact between a part of the support post 6 and a part of the base 4.

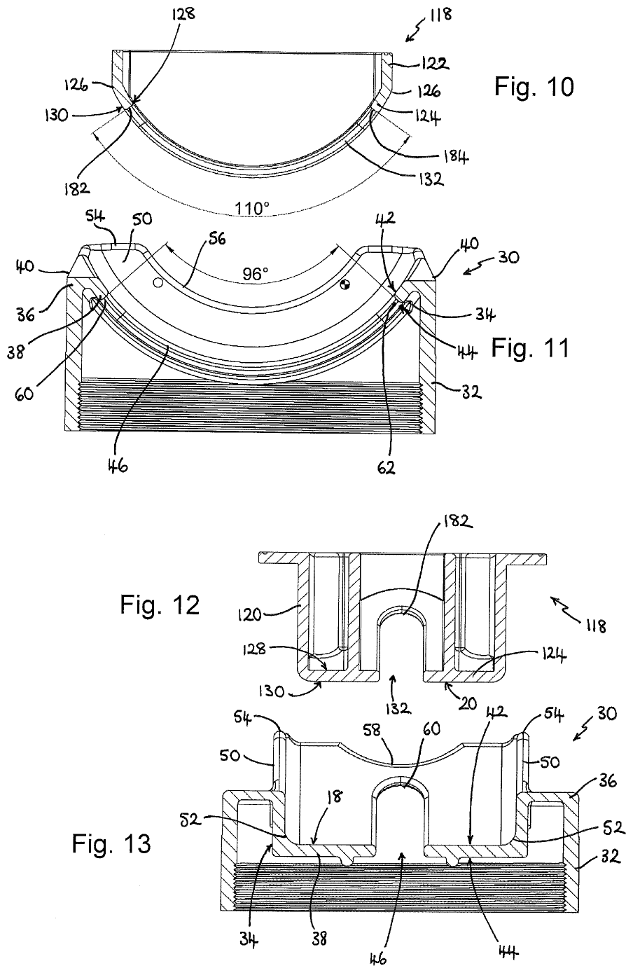

The structure and configuration of a preferred embodiment of the support post assembly 2 will now be described with particular reference to FIGS. 3, and 6 to 22.

The base 4 of the support post assembly 2 comprises a base plate 22 including an attachment portion or skirt portion 24 that extends outwardly from a raised portion or platform 26. Preferably the raised platform 26 is located centrally and the skirt portion 24 extends radially outwards from and surrounds the platform 26. In use the skirt portion 24 is secured to a part of a structure using suitable fixings. The skirt portion 24 may, therefore, include a plurality of holes 28 for receiving suitable fixings.

The base 4 comprises the first or lower bearing surface 18. In this embodiment, the first bearing surface 18 has a single direction of curvature and is curved along an axis of the bearing surface.

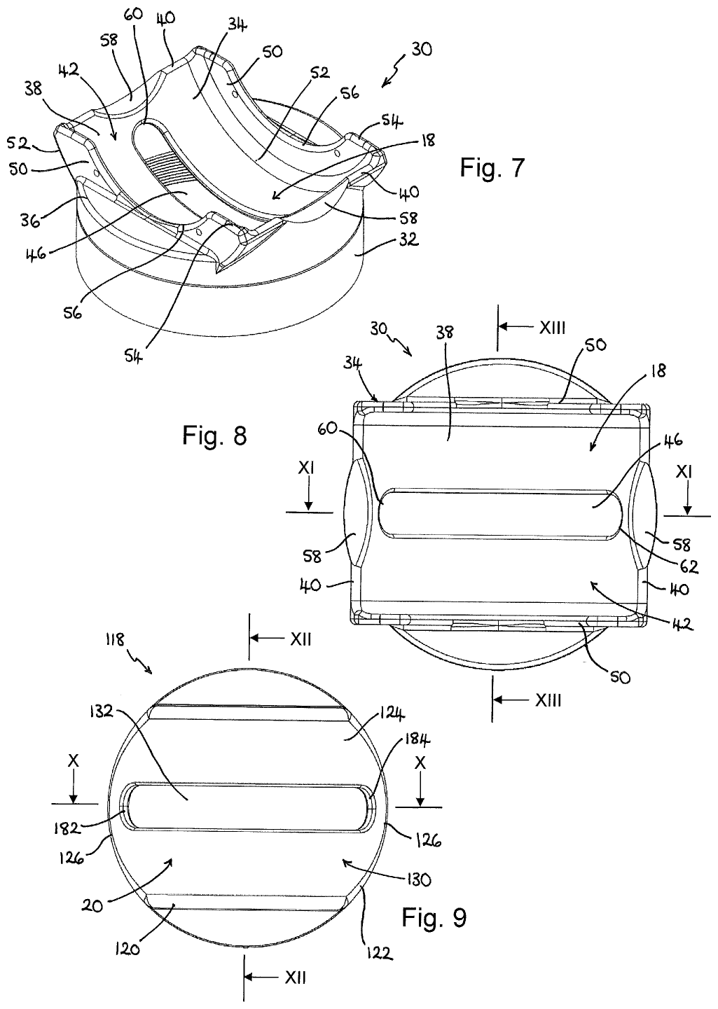

The lower bearing surface 18 is provided on a first bearing component 30 connected to the raised portion 26 of the base plate 22. An embodiment of the first bearing component 30 is shown most clearly in FIGS. 6 and 7. In this embodiment the first bearing component 30 comprises a side wall 32 and a seat portion 34 connected to a first end 36 of the side wall 32. The seat portion 34 includes a first bearing plate 38 extending along an axis between first and second ends 40. The first bearing plate 38 has a single direction of curvature along the axis and has a concave curvature, such that the first and second ends 40 extend in directions substantially away from the side wall 32. In particular, the first bearing plate 38 has opposite first and second faces 42, 44; the curvature of the first face 42 is concave and the curvature of the second face 44 is convex. The first face 42 provides the first bearing surface 18. The first bearing plate 38 includes an elongate slot 46 extending along the axis of the bearing plate 38. The slot 46 is configured to receive a clamping assembly 48 discussed further below.

Guide walls 50 extend from the concave side of the first bearing plate 38 along edges 52 of the bearing plate 38 between the first and second ends 40. The guide walls 50 are preferably straight along their length. A top or free edge 54 of each of the guide walls 50 includes a curved recess 56. This curved recess 56 may be formed by the guide wall 50 having a substantially constant height along its length, such that the curvature of the top edge 54 of the guide wall 50 follows the curvature of the first bearing plate 38. Each of the first and second ends 40 of the bearing plate 38 includes a depression or indentation 58. Each of the depressions 58 is disposed centrally between the guide walls 50.

The slot 46 in the first bearing plate 38 extends between the two depressions 58. A first end 60 of the slot 46 is disposed proximate but spaced from the depression 58 in the first end 40 of the bearing plate 38 and a second end 62 of the slot 46 is disposed proximate but spaced from the depression 58 in the second end 40 of the bearing plate 38.

In this embodiment of the support post assembly 2 the raised portion 26 of the base plate 22 includes a top plate 64 having central recess 66 and an aperture 68. A coupling member 70 comprises a support plate 72 having a central boss 74 and an aperture 76, and a side wall 78 extending from an edge of the support plate 72 in an opposite direction to the boss 74. The coupling member 70 is attached to the raised portion 26 of the base plate 22 such that the support plate 72 is in contact with the top plate 64 and the boss 74 is seated in the recess 66, with the apertures 68, 76 aligned. A fixing, in the form of a bolt 80, extends through the respective apertures 68, 76. A nut 82 secured to the bolt 80 secures the coupling member 70 to the base plate 22.

The first bearing component 30 is attached to the coupling member 70. Preferably the attachment is via complementary screw threads 84 on the first bearing component 30 and the coupling member 70. In this example, the coupling member 70 includes a screw thread 84 on an external surface of the side wall 78 and the first bearing component 30 includes a screw thread 84 on an internal surface of the side wall 32.

The coupling member 70 enables different bearing components and different support posts to be easily connected to the base plate 22. This may be advantageous if there is a fault or damage to a support post for example. Furthermore, in some circumstances the coupling member 70 and the first bearing component 30, together with the support post 6 and the safety line mount 8, may be separated and removed from the base plate 22 when the support post 6 is no longer required. This enables the base plate 22 to remain attached to the structure for subsequent attachment of the support post 6 when it is next required.

During use of the support post assembly 2 the coupling member 70 enables the orientation of the bearing surfaces 18, 20 and the support post 6 to be varied relative to the base plate 22 by rotation of the coupling member 70 with respect to the base plate 22. When a dynamic load is applied to the fall safety line, the support post 6 and the first bearing component 30 rotate relative to the base plate 22 such that the axis of the first bearing surface 18 is substantially parallel to the loading direction. This means that the rotational axis of the support post is oriented substantially perpendicular to direction of the applied dynamic load. It will be appreciated that this relative rotation is particularly advantageous when the support post 6 is constrained to pivot about a single axis 16.

It will be appreciated that in other embodiments the first bearing surface 18 and/or the first bearing component 30 may be integral with the base plate 22.

The support post 6 comprises a housing 86, a shock absorber 88 and the second or upper bearing surface 20. The second bearing surface 20 is connected to or is provided by the housing 86. The second bearing surface 20 has a single direction of curvature and is curved along an axis of the bearing surface 20.

The safety line mount 8 is connected to the housing 86 via the shock absorber 88. This enables some movement of the safety line mount 8 with respect to the housing 86 under certain conditions of lateral loading on the safety line mount 8.

The housing 86 comprises a tubular side wall or sleeve 90. In this embodiment the sleeve 90 is cylindrical. The housing 86 further comprises an end plate 92 attached to a first end of the sleeve 90 and which substantially closes or blocks the first end of the sleeve 90 so as to define a cavity or internal volume 94 within the sleeve 90. The end plate 92 includes a central aperture or hole 96 for receiving a part of the safety line mount 8. A flange 98 extends radially outwards from a second end of the sleeve 90. The flange 98 extends substantially perpendicularly from the sleeve 90 and extends around the full perimeter of the sleeve 90.

The shock absorber 88 comprises first and second resilient elements 100, 102 disposed on either side of a pivot. In this embodiment each of the first and second resilient elements 100, 102 is in the form of a resilient block. The resilient blocks 100, 102 are disposed on opposite sides of the end plate 92 of the housing 86; the aperture 96 in the end plate 92 of the housing 86 providing a pivot as described further below.

Each of the resilient blocks 100, 102 has a first end surface 104 and an opposite second end surface 106. The first end surface 104 of the first resilient block 100 is in contact with a first surface 93 of the end plate 92 such that the first resilient block 100 is disposed in the cavity 94 of the housing 86 and extends towards the second bearing surface 20. The first end surface 104 of the second resilient block 102 is in contact with an opposite second surface 95 of the end plate 92 such that the second resilient block 102 is disposed outside the housing 86 and extends away from the housing 86 and the second bearing surface 20.

Each of the resilient blocks 100, 102 includes a bore 108 extending between the respective first and second end surfaces 104, 106. Each of the bores 108 is aligned with the aperture 96 in the end plate 92 of the housing 86. The bores 108 are preferably cylindrical and have a diameter slightly smaller than a diameter of the aperture 96 in the housing end plate 92. Each of the bores 108 is preferably disposed centrally within the respective resilient block 100, 102.

In this embodiment each of the resilient blocks 100, 102 comprises a cylindrical portion 110, having a constant outer diameter, at a first end of the block, and a frusto-conical portion 112, having a tapered outer surface, at a second end of the block. Accordingly, the first end surface 104 of the block 100, 102 has a larger diameter than the second end surface 106 of the block 100, 102. The outer diameter of the first end of the resilient block 100, 102 is preferably the same as or slightly smaller than an internal diameter of the side wall 90 of the housing 86 such that there is no gap or only a minimal gap between an outer surface of the first resilient block 100 at its first end and an internal surface of the housing 86.

The resilient blocks 100, 102 are preferably made of an elastomeric material, for example an ethylene propylene rubber. In a preferred embodiment of the invention the resilient blocks 100, 102 are made from an ethylene propylene diene monomer (EPDM) rubber, which has good tear and abrasion resistance as well as good weather resistance.

A mounting plate 114 is disposed at the second end of the second resilient block 102. In particular, a first surface of the mounting plate 114 is in contact with the second end surface 106 of the second resilient block 102. The mounting plate 114 includes a hole 116 that is aligned with the bore 108 in the second resilient block 102. A diameter of the hole 116 is preferably smaller than the diameter of the bore 108. The mounting plate 114 may be adhered or otherwise secured to the second end surface 106 of the second resilient block 102. An outer diameter of the mounting plate 114 is preferably less than the outer diameter of the second end surface 106 of the resilient block 102.

In some embodiments the mounting plate 114 may be provided by an outer housing or cover that surrounds the second resilient element 102.

In this embodiment the upper bearing surface 20 is provided on a second bearing component 118 connected to the flange 98 of the housing 86. The second bearing component 118 comprises side walls 120, end walls 122 and a second bearing plate 124 connected to a first end of each of the side walls 120 and end walls 122. The second bearing component 118 is attached to the flange 98 of the housing 86 at a second end of each of the side walls 120 and end walls 122. The second bearing plate 124 extends along an axis between first and second ends 126 and has a single direction of curvature along the axis. The second bearing plate 124 has opposite first and second faces 128, 130. The curvature of the first face 128 is concave and the curvature of the second face 130 is convex. The second face 130 provides the second bearing surface 20. The second bearing plate 124 includes an elongate slot 132 extending along the axis. The slot 132 is configured to receive a part of the clamping assembly 48. The radius of curvature of the second bearing surface 20 is substantially the same as the radius of curvature of the first bearing surface 18.

The side walls 120 are preferably straight along their length. A distance between respective outer surfaces of the side walls 120 is preferably substantially the same as or slightly smaller than the distance between inner surfaces of the guide walls 50 of the first bearing component 30. In this way, the second bearing plate 124 is disposed between the guide walls 50 of the first bearing component 30, such that the second bearing surface 20 is seated on and in contact with the first bearing surface 18.

With the second bearing surface 20 seated on the first bearing surface 18, the slots 46, 132 in the respective bearing plates 38, 124 are aligned. Furthermore, the widths of the slots 46, 132 are preferably the same.

The clamping assembly 48 clamps the first and second bearing plates 38, 124 together such that the first and second bearing surfaces 18, 20 are in contact. The clamping assembly 48 therefore provides an arrangement for retaining the first and second bearing surfaces 18, 20 in contact with each other. Furthermore, the clamping assembly 48 applies a clamping force to the first and second bearing plates 38, 124 to prevent relative movement of the bearing surfaces 18, 20 below a threshold force.

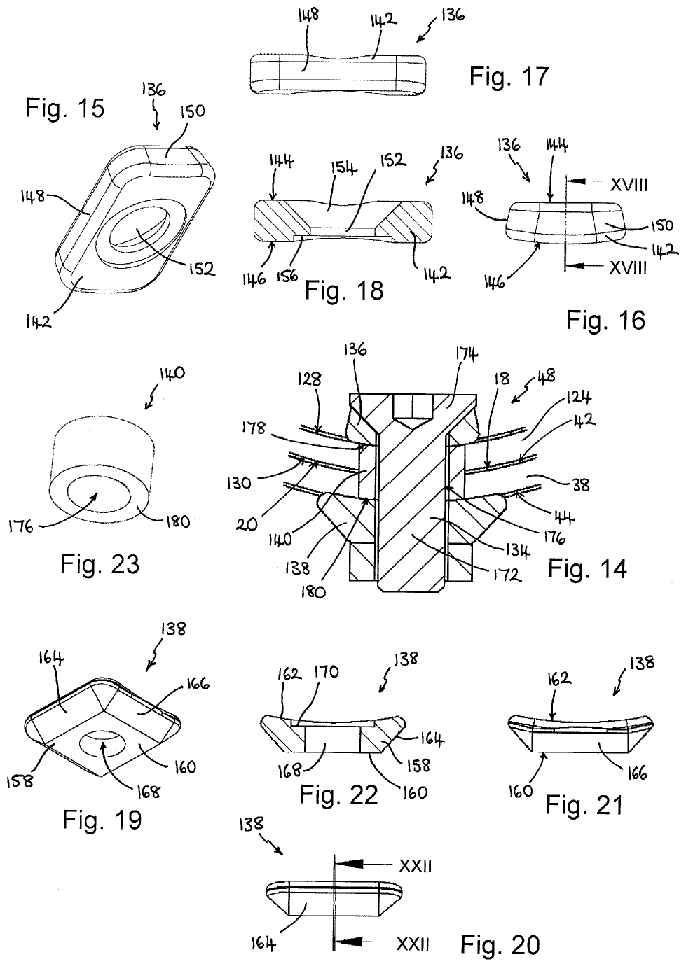

In this embodiment the clamping assembly 48 comprises a clamp pin 134, a first clamp member 136, a second clamp member 138 and a spacer 140, as shown most clearly in FIGS. 14 to 23.

The first clamp member 136, shown in FIGS. 15 to 18, comprises a main body 142 having opposite first and second faces 144, 146, opposite first and second sides 148 and opposite first and second ends 150. A bore 152 extends fully through the main body 142 between a first end terminating at the first face 144 and a second end terminating at the second face 146. The bore 152 is enlarged at the first end to provide a countersink 154. The bore 152 is also enlarged at the second end for receiving a part of the spacer 140. A shoulder 156 is therefore disposed between a central portion of the bore 152 and the increased diameter second end region of the bore 152.

The second face 146 of the main body has a convex curvature. The radius of curvature of the second face 146 is substantially the same as the radius of curvature of the first face 128 of the second bearing plate 124.

The second clamp member 138, shown in FIGS. 19 to 22, comprises a main body 158 having opposite first and second faces 160, 162, opposite first and second sides 164 and opposite first and second ends 166. A bore 168 extends fully through the main body 158 between a first end terminating at the first face 160 and a second end terminating at the second face 162. The bore 168 is enlarged at the second end for receiving a part of the spacer 140. A shoulder 170 is therefore disposed between a first region of the bore 168 and an increased diameter second region of the bore 168.

The second face 162 of the main body 158 has a concave curvature. The radius of curvature of the second face 162 is substantially the same as the radius of curvature of the second face 44 of the first bearing plate 38.

The clamp pin 134 includes a shaft 172 and a head 174. The shaft 172 extends from the head 174 towards a distal end of the shaft 172. The spacer 140 is in the form of a tubular element having a central longitudinal bore 176 and a circular cross-sectional shape. The spacer 140 extends along its axis between first and second ends 178, 180. A diameter of the bore 176 of the spacer 140 is substantially the same as or slightly larger than a diameter of the shaft 172 of the clamp pin 134. An external diameter of the spacer 140 is substantially the same as or slightly smaller than the widths of the slots 46, 132 in the bearing plates 38, 124. Furthermore, both the second end region of the bore 152 of the first clamp member 136 and the second region of the bore 168 of the second clamp member 138 have diameters that are substantially the same as or slightly larger than the outer diameter of the spacer 140.

The first clamp member 136 is seated on the second bearing plate 124 such that the second face 146 of the main body 142 is in contact with the first face 128 of the second bearing plate 124. The second clamp member 138 is seated on the first bearing plate 38 such that the second face 162 of the main body 158 is in contact with the second face 44 of the first bearing plate 38. The spacer 140 is disposed between the first and second clamp members 136, 138 and extends through the slots 46, 132 in the first and second bearing plates 38, 124. The clamp pin 134 extends through the first clamp member 136, the bore 176 of the spacer 140 and the second clamp member 138. The head 174 of the clamp pin 134 is seated in the countersink 154 of the first clamp member 136. The second clamp member 138 is retained on the distal end of the clamp pin 134 by a nut.

The first end 178 of the spacer 140 is seated on the shoulder 156 of the first clamp member 136 and the second end 180 of the spacer 140 is seated on the shoulder 170 of the second clamp member 138. In this way a length of the tubular spacer 140, between the first and second ends 178, 180, defines a spacing between the respective second faces 146, 162 of the clamp members 136, 138. Accordingly, the length of the spacer 140 defines the clamping force applied to the first and second bearing plates 38, 124 by the first and second clamp members 136, 138, and therefore determines the threshold force required to move the bearing surfaces 18, 20 with respect to each other.

Although in this embodiment the second clamp member 138 is retained on the distal end of the clamp pin 134 by a separate nut, in other embodiments the bore 168 of the second clamp member 138 may be threaded and the distal end of the clamp pin 134 may include complementary screw threads.

The clamping force applied to the bearing plates 38, 124 determines the magnitude of the threshold force above which the bearing surfaces 18, 20 are able to move with respect to each other. The clamping force therefore determines the minimum dynamic load or force that must be applied to the support post 6 to turn or pivot the support post 6 relative to the base 4. Furthermore, in this embodiment, a greater clamping force increases the frictional force between the opposing bearing surfaces 18, 20 which increases the amount of energy dissipated due to movement or sliding of the second bearing surface 20 relative to the first bearing surface 18.

In an initial configuration of the support post assembly 2 the first end 60 of the slot 46 in the first bearing plate 38 and a first end 182 of the slot 132 in the second bearing plate 124 are substantially aligned, and the second end 62 of the slot 46 in the first bearing plate 38 and a second end 184 of the slot 132 in the second bearing plate 124 are substantially aligned. The clamp pin 134 extends through the slots 46, 132 at a point substantially midway between the first and second ends 60, 182, 62, 184 of the slots 46, 132.

Returning to FIG. 2, the safety line mount 8 comprises a mounting member 186 engaged with the support post 6. The mounting member 186 comprises an elongate shaft 188 that extends between first and second ends 190, 192. A portion of the second end 192 of the shaft 188 is threaded to receive a nut 194. A head 196 of the mounting member 186 is disposed at the first end 190 of the shaft 188 and the head 196 comprises an aperture 198 for receiving a fall safety line or fall safety rail. In this embodiment the head 196 comprises an annular member integral with the shaft 188. In use, a fall safety line or fall safety rail is retained by and typically extends through the aperture 198 in the head 196 and extends from the mounting member 186 towards a neighbouring support post assembly 2 or other anchor point.

The shaft 188 of the mounting member 186 extends through the hole 116 in the mounting plate 114, through the bore 108 in the second resilient block 102, through the aperture 96 in the end plate 92 of the housing 86, and through the bore 108 in the first resilient block 100. The first end 190 of the shaft 188, therefore, protrudes from the mounting plate 114 and extends away from the support post 6 and the second end 192 of the shaft 188 protrudes from the first resilient block 100 and extends towards the second bearing plate 124. The nut 194 is secured to the threaded portion of the second end of the shaft 188 to retain the mounting member 186 in position relative to the shock absorber 88. A washer 200 may be disposed between the nut 194 and the first resilient block 100.

In preferred embodiments the hole 116 in the mounting plate 114 is threaded. Further, a portion of the shaft 188 proximate the head 196 is threaded to engage with the threaded mounting plate 114. This enables the shaft 188 to be secured to the shock absorber 88 with the head 196 at a distance above the mounting plate 114.

The safety line mount 8 is preferably configured such that the fall safety line or fall safety rail, when attached to the mounting member 186, extends from the support post 6 in a direction substantially perpendicular to the axes of the bearing plates 38, 124. In other words, the fall safety line or fall safety rail, when attached to the mounting member 186, preferably extends from the support post 6 in a direction substantially parallel to the rotational axis 16 of the support post 6.

The use of the support post assembly 2 will now be described in relation to persons working at height on a platform. A number of support posts 6 are preferably secured around the area of the platform, preferably in or proximate an edge region of the area. The fall safety line or fall safety rail is engaged with the head 196 of the safety line mount 8 of each of the support post assemblies 2, so that the fall safety line is retained in position with respect to each of the support posts 6. The fall safety line or fall safety rail applies a static line load to the mounting member 186. A person or worker is preferably attached to the fall safety line via a traveller which is able to slide along the fall safety line and pass over or around the safety line mounts 8 as the person moves around the work area.

If the person falls, the energy of the fall is transmitted via the traveller to the fall safety line. This applies a dynamic force or impulse to one or more of the safety line mounts 8 with which the fall safety line is engaged. In particular, the fall safety line applies a dynamic lateral force to the head 196 of the mounting member 186. This lateral force is, in turn, transmitted to the support post 6 via the shock absorber 88.

The lateral force applied to the mounting member 186 results in pivoting of the shaft 188 which causes deformation of each of the resilient blocks 100, 102 in the support post 6. In particular, a part of each of the resilient blocks 100, 102 is pressed against the fixed, non-rotating end plate 92 of the housing 86, thereby absorbing some of the energy of the fall in each of the resilient blocks 100, 102. Movement of the shaft 188 is constrained where this passes through the aperture 96 in the end plate 92 of the housing 86 and the mounting member 186 therefore pivots or turns about the aperture 96 in the end plate 92. The end plate 92 of the housing 86 therefore acts as a pivot plate for the shaft 188 of the mounting member 186. The pivoting movement of the mounting member 186 causes the mounting plate 114 to compress a portion of the second, upper resilient block 102, and because the second end 192 of the shaft 188 is constrained within the bore 108 of the first resilient block 100 by the nut 194, this pivoting movement additionally causes a portion of the first, lower resilient block 100 to be compressed.

At the point where the resilient blocks 100, 102 have been compressed to their maximum extent by turning of the mounting member 186, any additional force applied to the safety line mount 8 is transmitted to the housing 86 of the support post 6. If the magnitude of this additional force is above the threshold force for relative movement of the bearing surfaces 18, 20, the second bearing surface 20 moves with respect to the first bearing surface 18. In particular, the second bearing surface 20 slides with respect to the first bearing surface 18 in a direction parallel to the axes of the bearing surfaces 18, 20. Because the bearing plates 38, 124 are constrained in contact with each other, the curvature of the bearing surfaces 18, 20 is such that this sliding movement causes turning or pivoting of the support post 6 relative to the base 4.

The direction of the dynamic force applied to the safety line mount 8 by the falling person may cause the support post 6 and the first bearing component 30 to rotate relative to the base 4 about the longitudinal axis 12 of the support post 6. Relative rotation between the coupling member 70 and the base plate 22 will occur, if sufficient force is applied, unless and until the axes of the bearing plates 38, 124 are aligned with, i.e. parallel to, the direction of the applied force.

Furthermore, the arrangement of the bearing components 30, 118 and clamping assembly 48 are such that the second bearing surface 20 may slide with respect to the first bearing surface 18 in one of two opposite directions. In a first direction the bearing surfaces 18, 20 are able to slide over each other until the clamp pin 134 extends through the slots 46, 132 at the first end 60 of the slot 46 in the first bearing plate 38 and the second end 184 of the slot 132 in the second bearing plate 124. In a second direction the bearing surfaces 18, 20 are able to slide over each other until the clamp pin 134 extends through the slots 46, 132 at the second end 62 of the slot 46 in the first bearing plate 38 and the first end 182 of the slot 132 in the second bearing plate 124. In either one of these two positions the support post 6 is pivoted with respect to the base 4 to its full extent given the configuration of the bearing components 30, 118, and the support post assembly 2 is in an activated configuration.

The length of the slot 46 in the first bearing plate 38 is preferably such that the slot 46 extends through an angle of between 90° and 100°, and most preferably about 96°. The length of the slot 132 in the second bearing plate 124 is preferably such that the slot 132 extends through an angle of between 100° and 120°, and most preferably about 110°. In this way, the support post 6 rotates through an angle of about 90° between the initial configuration and the activated configuration of the support post assembly 2.

In the activated configuration a part of the side wall 90 of the housing 86 of the support post 6 may contact the first bearing plate 38 to limit further rotation of the support post 6. In particular the side wall 90 of the housing 86 may be seated in the depression 58 at the first or second end 40 of the first bearing plate 38 in the activated configuration.

As the bearing surfaces 18, 20 slide over one another the friction between the surfaces 18, 20 dissipates some of the energy of the fall. The greater the angle through which the support post 6 rotates with the bearing surfaces 18, 20 in contact with each other, the greater the amount of energy that is dissipated due to the friction between the bearing surfaces 18, 20. For a given angle of rotation, the amount of energy dissipated by the bearing surfaces 18, 20 may be increased by increasing the length of the bearing surfaces 18, 20, i.e. increasing the radius of curvature of the bearing surfaces 18, 20, by increasing the distance between the centre of rotation and the respective bearing surface 18, 20.

During rotation of the support post 6 it is preferable if the head 196 of the mounting member 186, to which the fall safety line is attached, moves through a minimal distance to minimise the distance added to the fall of the user.

It will be appreciated that during use of the support post assembly 2 described above, if a relatively small force is applied to the safety line mount 8 the mounting member 186 is displaced or pivoted relative to the housing 86 of the support post 6 and energy is dissipated by deformation of the resilient members 100, 102 of the shock absorber 88. A smaller dynamic force may be applied to the fall safety line or fall safety rail during, for example, normal movement of the person around the work area. If a relatively larger dynamic force is applied to the safety line mount 8, indicative of the person falling, after some energy dissipation by the shock absorber 88, at least a part of the force is transferred to the housing 86 of the support post 6. If this larger dynamic force exceeds the predetermined threshold force so as to cause the bearing surfaces 18, 20 to slide with respect to each other, at least some of the energy of the fall is dissipated due to friction between the opposing bearing surfaces 18, 20.

In the above embodiment the bearing surfaces 18, 20 were described as being in contact with each other. It will be appreciated that, depending on the materials from which the bearing surfaces 18, 20 are made, a layer of lubricant such as grease may be disposed between the opposing bearing surfaces 18, 20. In preferred embodiments the bearing surfaces 18, 20 are made of a suitable metal such as stainless steel. In other embodiments one or both of the bearing surfaces 18, 20 may be made of a suitable, hard polymeric material.

A support post assembly 2 according to the present invention comprises a retaining element or retaining assembly 202 that retains the bearing surfaces 18, 20 in contact with each other. The retaining assembly 202 may apply a clamping force to the bearing surfaces 18, 20, or may constrain the bearing surfaces 18, 20 in another way such that they remain in contact with each other, such that during relative movement of the bearing surfaces 18, 20 energy is dissipated due to friction between the bearing surfaces 18, 20. The support post assembly 2 further comprises a detent assembly 204 that is configured to prevent relative movement of the bearing surfaces 18, 20 below a threshold force and to permit relative movement once an applied force exceeds the threshold force.

In some embodiments the detent assembly 204 and the retaining assembly 202 may be provided by a single element, unit or assembly. For example, in the above described embodiment of the support post assembly 2, the clamping assembly 48 provides the function of both the retaining assembly 202 and the detent assembly 204. In other embodiments the retaining assembly 202 and the detent assembly 204 may be separate and distinct. For example, the detent assembly 204 may be in the form of a shear pin or other frangible connection between the first bearing component 30 and the second bearing component 118; the shear pin or frangible connection being configured to break at a predetermined threshold force. The retaining assembly 202 may comprise a clamp, a clip, a channel or a sleeve, for example, that retains the bearing surfaces 18, 20 in contact with each other.

It is desirable if the support post assembly 2 is configured such that the frictional force between the bearing surfaces 18, 20 is adjustable. This allows the threshold force required to move the bearing surfaces 18, 20 with respect to each other to be varied, for example to accommodate different arrangements of fall safety line. A taught fall safety line extending between neighbouring support post assemblies 2 may apply a different static line load to the support post 6 compared to a rigid fall safety rail. The additional dynamic load or force then applied to the fall safety line or fall safety rail due to a person falling leads to a different threshold force at which the support post assembly 2 should activate to move the support post 6 from the initial configuration to the activated configuration to dissipate some of the energy of the fall.

Although in the above embodiment the support post 6 was constrained to turn or pivot about a single axis due to the curvature of each of the bearing surfaces 18, 20 being in single direction, in other embodiments the bearing surfaces may be configured such that the support post 6 can turn about more than one axis relative to the base 4. In some embodiments it may be desirable for the support post 6 to be able to turn about a plurality of axes. In these embodiments the connection between the support post 6 and the base 4 may comprise a ball and socket joint. In these embodiments the first bearing surface may be provided by a hollow or substantially hemi-spherical socket and the second bearing surface may be provided by a rounded or part-spherical ball-shaped bearing member.

In the above embodiment the support post 6 comprises a shock absorber 88 that absorbs or dissipates a first amount of energy when a relatively small dynamic load is applied to the safety line mount 8. In other embodiments the support post 6 may not include a shock absorber 88 and the safety line mount 8 may be rigidly connected to the housing 86 of the support post 6.

It will be clear to a person of skill in the art that the support post assembly 2 of the present invention does not have to be mounted to a floor or a horizontal surface, but may be mounted on a sloping or vertical surface such as the face of a wall, or an inverted surface such as a ceiling. As such the base 4 may not be located below the support post 6 when the support post assembly 2 is mounted on a supporting surface.

The support post assembly of the present invention provides an improved fall safety line support able to absorb some of the energy from a fall of a worker secured to the fall safety line.

1. A support post assembly for supporting a fall safety line comprising:
a base;
a support post to which a fall safety line is connectable, the support post having a longitudinal axis;
cooperating curved bearing surfaces disposed between the base and the support post; and
a detent assembly for preventing relative movement of the bearing surfaces below a threshold force, application of a force to the support post by the fall safety line above the threshold force causing the support post to pivot with respect to the base such that the bearing surfaces slide with respect to each other and friction between the bearing surfaces dissipates energy.

2. (canceled)

3. (canceled)

4. A support post assembly as claimed in claim 1, wherein the assembly comprises a single axis of rotation about which the support post pivots with respect to the base due to said relative sliding of the bearing surfaces, wherein the support post is able to pivot in two opposite directions about said axis of rotation depending on the direction of the applied force, wherein the support post is rotatable relative to the base about its longitudinal axis.

5. (canceled)

6. (canceled)

7. A support post assembly as claimed in claim 1, wherein the base comprises a base plate securable to a structure and the support post assembly comprises a coupling member disposed between one of the bearing surfaces and the base plate permitting rotation of the bearing surfaces and support post relative to the base plate about the longitudinal axis of the support post.

8. A support post assembly as claimed in claim 1, wherein the assembly comprises a plurality of axes of rotation about which the support post can pivot with respect to the base due to said relative sliding of the bearing surfaces, wherein the support post assembly comprises a ball and socket joint between the support post and the base.

9. (canceled)

10. (canceled)

11. (canceled)

12. (canceled)

13. A support post assembly as claimed in claim 1, wherein the support post comprises a first one of the curved bearing surfaces and the base comprises a second one of the curved bearing surfaces, the first bearing surface having a convex curvature and second bearing surface having a concave curvature, wherein the first bearing surface is provided by a first bearing plate and the second bearing surface is provided by a second bearing plate.

14. A support post assembly as claimed in claim 13, wherein each of the first and second bearing plates includes an elongate slot extending along a direction of curvature of the bearing plate, and a pin extends through said slots to connect the bearing plates.

15. A support post assembly as claimed in claim 1, further comprising a retaining assembly configured to retain the bearing surfaces in contact with each other and prevent separation of the base and the support post.

16. A support post assembly as claimed in claim 15, wherein the retaining assembly is adjustable to vary the frictional force between the bearing surfaces during relative sliding of the bearing surfaces.

17. A support post assembly as claimed in claim 15, wherein the retaining assembly is configured to apply a clamping force to the bearing surfaces.

18. (canceled)

19. A support post assembly as claimed in claim 13, wherein the retaining assembly and the detent assembly are provided by a single clamping assembly configured to apply a clamping force to the bearing surfaces, wherein the clamping assembly comprises a first clamping member arranged to apply a force to the first bearing plate and a second clamping member arranged to apply a force to the second bearing plate.

20. (canceled)

21. A support post assembly as claimed in claim 19, wherein the clamping assembly comprises a spacer disposed between the first and second clamping members, the spacer limiting the minimum distance between the first and second clamping members.

22. A support post assembly as claimed in claim 21, wherein the spacer comprises a tubular member surrounding a shaft of a pin.

23. A support post assembly as claimed in claim 1, wherein the detent assembly comprises a shear pin configured to break at the threshold force.

24. (canceled)

25. (canceled)

26. A support post assembly as claimed in claim 1, further comprising a mounting member connected to the support post, wherein the support post comprises a shock absorber and the mounting member is connected to the support post by the shock absorber, wherein the shock absorber comprises a resilient element and a force applied to the mounting member by a fall safety line causes apart of the resilient element to be deformed.

27. (canceled)

28. A support post assembly as claimed in claim 26, wherein the mounting member is pivotally connected to the support post, wherein the shock absorber comprises a first resilient element on a first side of said pivotal connection and a second resilient element on a second side of said pivotal connection, and movement of the mounting member due to a force applied by the fall safety line causes both of the first and second resilient elements to deform.

29. A support post assembly as claimed in claim 26, wherein the resilient element is an elastomeric block.

30. A support post as claimed in claim 29, wherein the mounting member extends through a bore in the resilient block.

31. A support post assembly as claimed in claim 26, wherein the shock absorber and the detent assembly are configured such that application of a force to the mounting member by the fall safety line above the threshold force fully deforms the shock absorber and subsequently transmits a force to one of the bearing surfaces to cause the bearing surfaces to slide with respect to each other.

32. (canceled)

33. (canceled)

34. (canceled)

35. (canceled)

36. (canceled)
